(19) United States
(12) Patent Application Publication
(10) Pub. No.: US 2026/0301712 A1
(43) Pub. Date: Oct. 1, 2026

(54) INFORMATION PROCESSING SYSTEM

(71) Applicant: FUJIFILM Business Innovation Corp., Tokyo (JP)

(72) Inventors: Yasushi ICHINOWATARI, Kanagawa (JP); Mitsuharu ITO, Kanagawa (JP)

(73) Assignee: FUJIFILM Business Innovation Corp., Tokyo (JP)

(21) Appl. No.: 19/302,180

(22) Filed: Aug. 18, 2025

(30) Foreign Application Priority Data
Mar. 26, 2025 (JP) 2025-051600

(51) Int. Cl. G09G 5/38; G06T 3/40; G09G 5/373

(52) U.S. Cl. CPC G09G 5/38; G06T 3/40; G09G 5/373; G09G 2340/045; G09G 2340/0464

(57) ABSTRACT

An information processing system includes a processor configured to acquire position information that is information on a position of a second image with respect to a first image, the second image being movable with respect to the first image, and determine, based on the acquired position information, a display position of the second image after enlargement or reduction of the first image in a direction of the enlargement or reduction.

### CROSS-REFERENCE TO RELATED APPLICATIONS

This application is based on and claims priority under 35 USC 119 from Japanese Patent Application No. 2025-051600 filed Mar. 26, 2025.

### BACKGROUND

### (i) Technical Field

The present disclosure relates to an information processing system.

### (ii) Related Art

Japanese Unexamined Patent Application Publication No. 2015-028769 describes an information processing device including a processor that displays a predetermined popup menu in response to a predetermined operation for invoking the popup menu and displays an enlarged image obtained by enlarging an enlargement target area, which is a partial area in an image, in a superimposed manner on the image in response to a predetermined operation for enlarging and displaying the enlargement target area.

### SUMMARY

A plurality of images such as a first image and a second image may be displayed on a screen.

In this context, a configuration is considered where the first image is enlarged or reduced with the second image always remaining unmoved, or with the second image always moving by the amount corresponding to the enlargement or the reduction of the first image. With this configuration, the position of the second image after the enlargement or the reduction of the first image is determined without considering the positional relationship between the two images before the enlargement or the reduction of the first image.

Aspects of non-limiting embodiments of the present disclosure relate to enabling the position of the second image after the enlargement or the reduction of the first image to be determined considering the positional relationship between the first image and the second image before the enlargement or the reduction of the first image.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire position information that is information on a position of a second image with respect to a first image, the second image being movable with respect to the first image; and determine, based on the acquired position information, a display position of the second image after enlargement or reduction of the first image in a direction of the enlargement or reduction.

### BRIEF DESCRIPTION OF THE DRAWINGS

Exemplary embodiments of the present disclosure will be described in detail based on the following figures, wherein:

FIG. 1 is a diagram illustrating an information processing system to which a first exemplary embodiment is applied;

FIG. 2 is a diagram illustrating a hardware configuration example of a user terminal to which the first exemplary embodiment is applied;

FIG. 3 is a diagram illustrating a hardware configuration example of a server to which the first exemplary embodiment is applied;

FIG. 4 is a diagram illustrating an example of a browser window displayed on the user terminal;

FIGS. 5A and 5B are diagrams illustrating examples of a display position of a floating menu after enlargement of a work area, FIG. 5A illustrating an example of a case where the floating menu is always moved by the amount corresponding to the enlargement of the work area, FIG. 5B illustrating an example of a case where the first exemplary embodiment is applied;

FIGS. 6A and 6B are diagrams illustrating examples of a flow of processes for determining the display position of the floating menu after the enlargement or reduction of the work area, FIG. 6A illustrating an example of a case where the work area is enlarged, FIG. 6B illustrating an example of a case where the work area is reduced;

FIG. 7 is a diagram illustrating an example of a browser window in a case where the floating menu is arranged outside the work area;

FIG. 8 is a diagram illustrating an example in which a search menu for performing a search on a tree is displayed to be movable with respect to the work area;

FIG. 9 is a diagram for explaining how the display position of the floating menu is determined according to a second exemplary embodiment; and

FIG. 10 is a diagram illustrating an example of a flow of processes for determining the display position of the floating menu after enlargement or reduction of the work area.

### DETAILED DESCRIPTION

Exemplary embodiments of the present disclosure will be described below in detail with reference to the accompanying drawings.

### First Exemplary Embodiment

### System Configuration

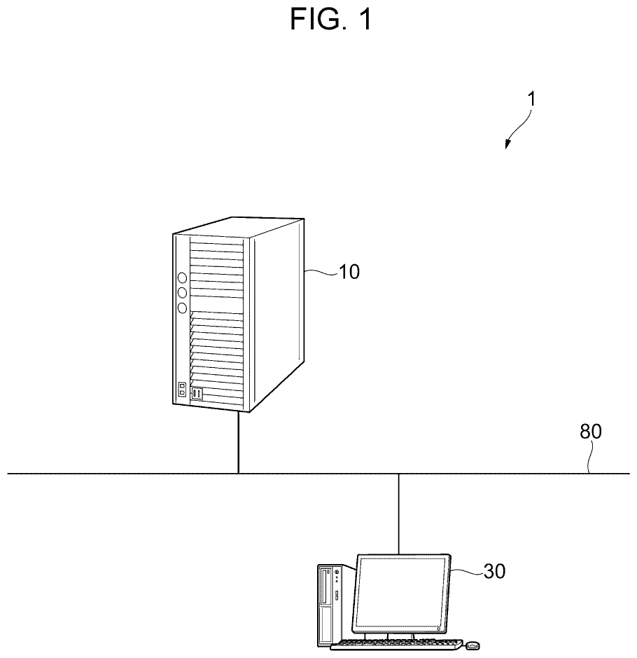

FIG. 1 is a diagram illustrating an information processing system 1 to which a first exemplary embodiment is applied.

The information processing system 1 according to the first exemplary embodiment includes a server 10 and a user terminal 30. The server 10 and the user terminal 30 are connected to each other via a network 80.

The server 10 is a computer that provides a web service. The web service is such a service that enables a user to access web pages via the Internet. In the first exemplary embodiment, a case where the user uses a web application operating on the web via the web service will be described as an example. The server 10 may be a so-called local server, a virtual server (for example, a cloud server) established by using resources on a network, or the like.

The user terminal 30 is a computer used by the user. A web browser is installed in the user terminal 30. With this web browser, the user terminal 30 uses the web service provided by the server 10. Examples of the user terminal 30 include a desktop personal computer (PC), a notebook PC, a portable information terminal, and the like.

The network 80 is an information communication network used for communication between the server 10 and the user terminal 30. The type of the network 80 is not particularly limited as long as data can be transmitted and received, and may be, for example, the Internet, a local area network (LAN), a wide area network (WAN), or the like. The communication line used for data communication may be a wired network or a wireless network. A plurality of networks or communication lines may be used for connecting apparatuses to each other.

While FIG. 1 illustrates one server 10 and one user terminal 30, this should not be construed in a limiting sense. A plurality of the user terminals 30 may be connected to the server 10, and the information processing system 1 may include a plurality of the servers 10.

### Hardware Configuration of User Terminal 30

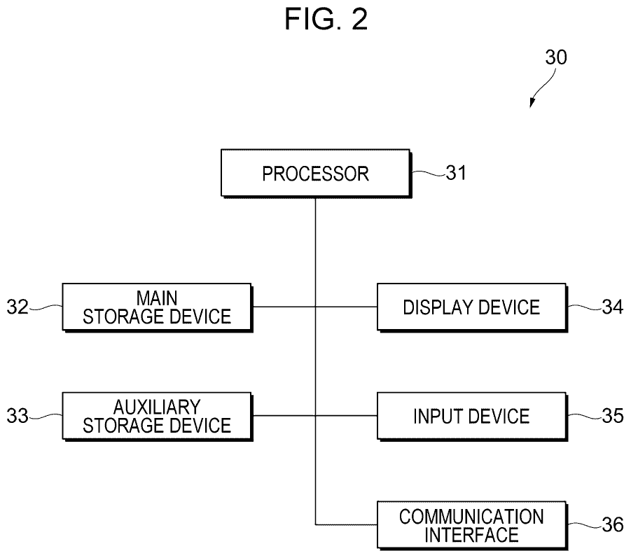

FIG. 2 is a diagram illustrating a hardware configuration example of the user terminal 30 to which the first exemplary embodiment is applied.

As illustrated in the figure, the user terminal 30 includes a processor 31 serving as an arithmetic means, as well as a main storage device (main memory) 32 and an auxiliary storage device 33 serving as storage means. As the processor 31, for example, various arithmetic circuits such as a central processing unit (CPU), a graphics processing unit (GPU), an application specific integrated circuit (ASIC), and a field-programmable gate array (FPGA) are used. The processor 31 loads a program stored in the auxiliary storage device 33 into the main storage device 32 and executes the program. For example, a random access memory (RAM) is used as the main storage device 32. As the auxiliary storage device 33, for example, a magnetic disk device, a solid state drive (SSD), or the like is used.

The user terminal 30 also includes a display device (display) 34, an input device 35 with which the user performs an input operation, and a communication interface 36 for connection to the network 80. As the input device 35, for example, a touch panel integrated with the display device 34 is used. A keyboard, a mouse, or the like may be used as the input device 35. The hardware configuration illustrated in FIG. 2 is merely an example and this should not be construed in a limiting sense. For example, a nonvolatile memory such as a flash memory or a read only memory (ROM) may be used as the storage device.

### Hardware Configuration of Server 10

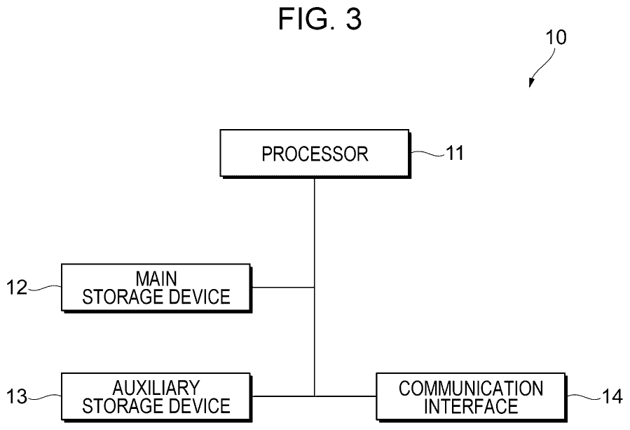

FIG. 3 is a diagram illustrating a hardware configuration example of the server 10 to which the first exemplary embodiment is applied.

As illustrated in the figure, the server 10 includes a processor 11 serving as an arithmetic means, as well as a main storage device (main memory) 12 and an auxiliary storage device 13 serving as storage means. As the processor 11, for example, various arithmetic circuits such as a CPU, a GPU, an ASIC, and an FPGA are used. The processor 11 loads a program stored in the auxiliary storage device 13 into the main storage device 12 and executes the program. For example, a RAM is used as the main storage device 12. As the auxiliary storage device 13, for example, a magnetic disk device, an SSD, or the like is used. The server 10 also includes a communication interface 14 for connecting to the network 80.

### Display of Browser Window 100

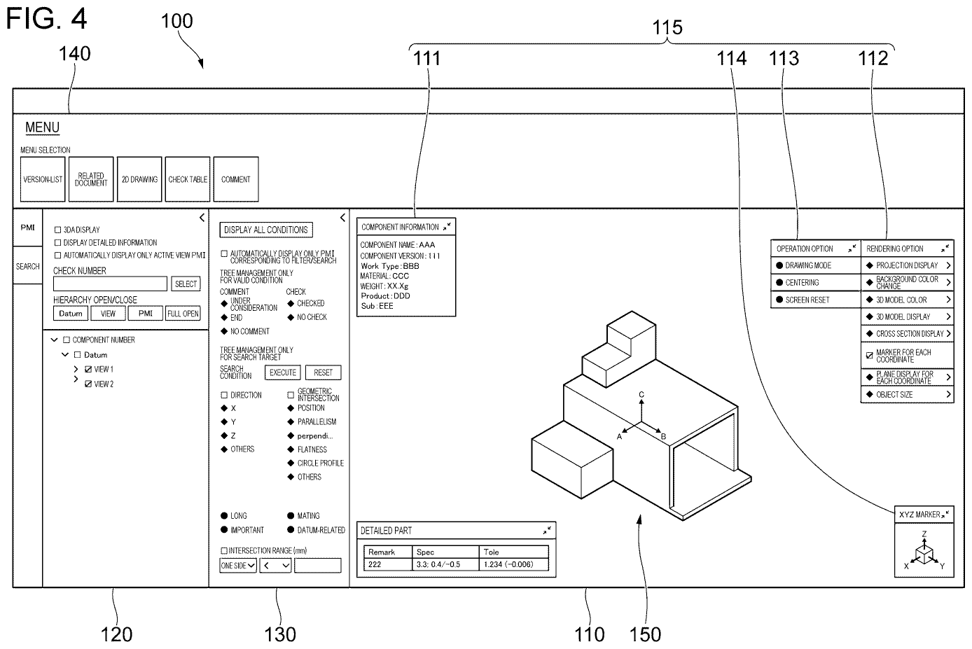

FIG. 4 is a diagram illustrating an example of a browser window 100 displayed on the user terminal 30. With reference to FIG. 4, a situation where the user uses a web application for editing a 3D model will be described as an example.

As illustrated in the figure, the browser window 100 includes a work area 110 that displays a 3D model 150. Here, the 3D model 150 is the target of work by the user. The work area 110 is an example of a first image.

The work area 110 displays a component information menu 111 indicating component information of the 3D model 150 and a rendering option menu 112 indicating information on the display mode of the 3D model 150. The work area 110 also displays an operation option menu 113 indicating options for performing a specific operation on the 3D model 150 and an XYZ marker 114 for guiding the three-dimensional directions of the 3D model 150.

The component information menu 111 displays a name, a material, a weight, and the like of a component. The rendering option menu 112 displays whether to display a projected image, a change in background color, a change in the color of the 3D model 150, and the like, and a user selection thereon causes a change in the display mode. On the operation option menu 113, a change in editing mode, a change in the arrangement of the 3D model 150, and the like are displayed, and the user can select an operation option.

The component information menu 111, the rendering option menu 112, the operation option menu 113, and the XYZ marker 114 are each a floating menu 115 arranged in the work area 110. The floating menu 115, the display position of which is movable with respect to the work area 110 in response to a user operation, is a menu on which necessary items are operated while being arranged at suitable positions in accordance with the current work content of the user. The floating menu 115 is displayed in a fixed manner with respect to the work area 110. This means that, for example, even when the user performs operations such as enlargement, reduction, or movement on the 3D model 150 displayed in the work area 110, the display position of the floating menu 115 does not change. For example, the user changes the display position of the floating menu 115 by clicking and dragging the floating menu 115. The floating menu 115 is displayed at a position determined by the user, in a fixed manner with respect to the work area 110. What is used as the floating menu 115 varies depending on a stage of an operation performed by the user. Thus, a necessary menu can be changed to a position that is easy to use, or a menu that is not to be used can be folded and hidden. The floating menu 115 is displayed in a fixed manner with respect to the work area 110 but the user can freely move the floating menu 115 after being fixed. Thus, the fixing can be regarded as temporary or provisional.

The floating menu 115 is an example of a second image indicating information on an operation on the work area 110. The user can freely change the display position of the floating menu 115 within the work area 110.

The browser window 100 also includes a tree 120 indicating functions related to display switching in the work area 110, and a search menu 130 for searching the tree 120. The browser window 100 also includes a tab 140 indicating a menu related to an operation in the browser window 100.

The tree 120 is an important function used for any work under the use of the web application, is always arranged at the same position, and provides the user with a consistent operation guide. In the tree 120, for example, a menu related to display of 3-Dimensional Annotated Models (3DA) or display of detailed information is displayed. Displaying and hiding of these items are switched according to selection by the user. The tree 120 displays a filename and an item for switching between displaying and hiding for each file. The item for switching between displaying and hiding for each file is, for example, a size tolerance or a geometric tolerance, and these pieces of information may be folded and hidden.

When the search menu 130 and the tab 140 are not needed, they can be folded and hidden. The work area 110 is enlarged or reduced depending on whether the search menu 130 and the tab 140 are displayed or not. The work area 110 is also enlarged or reduced in accordance with a change in the size of the browser window 100. In the first exemplary embodiment, when the work area 110 is enlarged or reduced, the display position of the floating menu 115 after the enlargement or reduction is determined based on the display position of the floating menu 115 before the enlargement or reduction.

The work area 110 is enlarged or reduced by, for example, clicking and dragging with a mouse cursor positioned on an outer edge of the work area 110. The enlargement or reduction may also be implemented in response to a gesture such as a pinch-out gesture or a pinch-in gesture performed by the user touching the screen.

### Display Position Determination

The processor 31 of the user terminal 30 acquires position information of the floating menu 115 before the enlargement or the reduction of the work area 110. The processor 31 acquires the position information as information on the position of the floating menu 115 with respect to the work area 110. The position with respect to the work area 110 is, for example, a position on coordinates, with a specific point in the work area 110 set as the origin. Additionally, the position may be the area where the floating menu 115 is located when the work area 110 is divided into a plurality of areas.

Based on the acquired position information, the processor 31 determines the display position of the floating menu 115 after the enlargement or the reduction of the work area 110. In the first exemplary embodiment, the processor 31 determines the display position of the floating menu 115 in the direction of enlargement or reduction. For example, when the work area 110 is enlarged toward the left side on the screen illustrated in FIG. 4, the processor 31 determines the display position of the floating menu 115 in the left-right direction.

A case where the work area 110 is enlarged toward the left side on the screen illustrated in FIG. 4 will be described. In this case, the work area 110 is enlarged with the left end of the work area 110 moving in a direction away from the right end on the opposite side. Based on the distances from the floating menu 115 to the left end and to the right end of the work area 110 before the enlargement, the processor 31 determines the display position of the floating menu 115 after the enlargement. When the work area 110 before the enlargement is divided into two equal left and right areas, the processor 31 determines the display position of the floating menu 115 after the enlargement based on which of the left and right areas the floating menu 115 belongs to.

When the floating menu 115 before the enlargement is closer to the left end than to the right end of the work area 110, the processor 31 moves the display position of the floating menu 115 toward the left side, which is the downstream side in the direction of the enlargement. In this case, for example, the processor 31 determines the display position of the floating menu 115 after the enlargement while maintaining the distance between the left end of the work area 110 and the floating menu 115.

When the floating menu 115 before the enlargement is closer to the right end than to the left end of the work area 110, the processor 31 moves the display position in a manner different from that in a case where the floating menu 115 before the enlargement is closer to the left end than to the right end of the work area 110. For example, the processor 31 keeps the floating menu 115 at the position before the enlargement.

A case where the work area 110 is reduced toward the right side on the screen illustrated in FIG. 4 will be described. In this case, the work area 110 is reduced with the left end of the work area 110 moving in a direction toward the right end on the opposite side. In this case, the processor 31 determines the display position of the floating menu 115 after the reduction based on the distances from the floating menu 115 before the reduction to the left end and to the right end of the work area 110. When the work area 110 before the reduction is divided into two equal left and right areas, the processor 31 determines the display position of the floating menu 115 after the reduction based on which of the left and right areas the floating menu 115 belongs to.

When the floating menu 115 before the reduction is closer to the left end than to the right end of the work area 110, the processor 31 moves the display position of the floating menu 115 toward the right side, which is the downstream side in the direction of reduction. In this case, for example, the processor 31 determines the display position of the floating menu 115 after the reduction while maintaining the distance between the left end of the work area 110 and the floating menu 115.

When the floating menu 115 before the reduction is closer to the right end than to the left end of the work area 110, the processor 31 moves the display position in a manner different from that in a case where the floating menu 115 before the reduction is closer to the left end than to the right end of the work area 110. For example, the processor 31 keeps the floating menu 115 at the position before the reduction.

In this manner, the processor 31 displays the floating menu 115 at the determined display position.

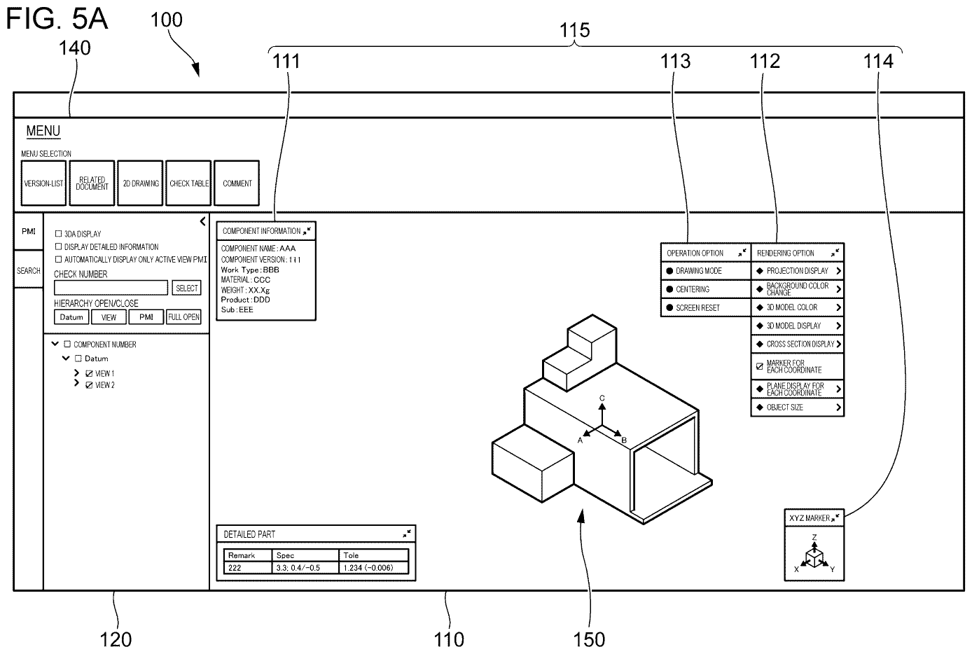

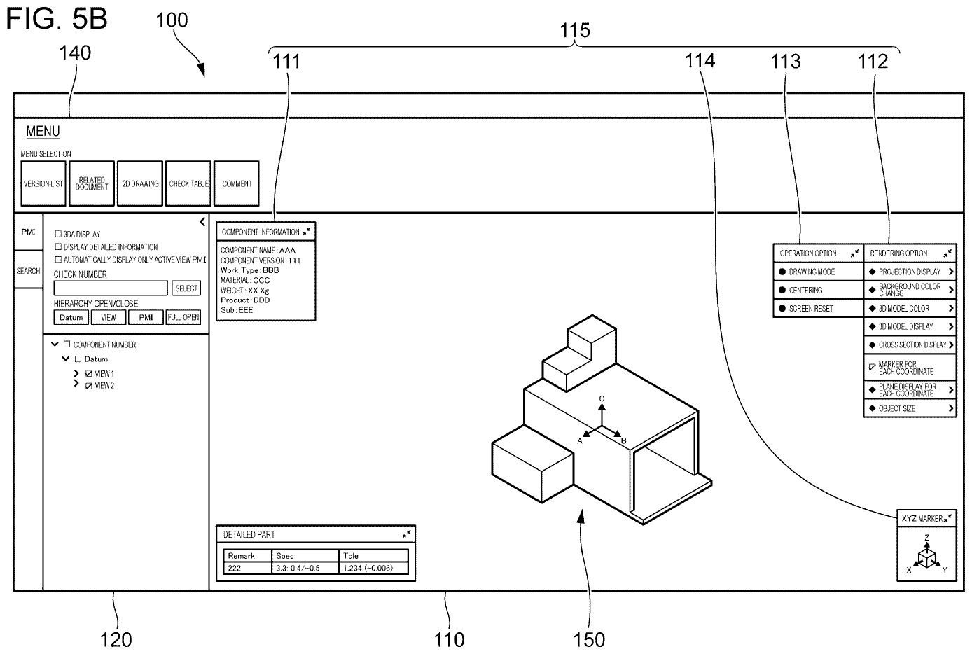

FIGS. 5A and 5B are diagrams illustrating examples of the display position of the floating menu 115 after the enlargement of the work area 110. FIG. 5A illustrates an example of a case where the floating menu 115 is always moved by the amount corresponding to the enlargement of the work area 110. FIG. 5B illustrates an example of a case where the first exemplary embodiment is applied.

FIGS. 5A and 5B illustrate examples in which the work area 110 is enlarged toward the left side in response to the search menu 130 (see FIG. 4) being determined to be hidden in the state illustrated in FIG. 4.

As illustrated in FIG. 5A, the floating menu 115 displayed, which was arranged in the vicinity of the right end of the work area 110 before the enlargement, is shifted toward the center of the work area 110 after the enlargement. Depending on the degree of enlargement of the work area 110 or the size of the 3D model 150, the moved floating menu 115 may be displayed to overlap with the 3D model 150. The floating menu 115 thus moved makes the central portion of the work area 110 less visible. Thus, the floating menu 115 always moving by the amount corresponding to the enlargement of the work area 110 may compromise visibility and workability for the user.

With the present exemplary embodiment, the visibility and workability are prevented from being thus compromised. As illustrated in FIG. 5B, according to the first exemplary embodiment, the component information menu 111, which was arranged in the vicinity of the left end of the work area 110 before the enlargement, is still arranged in the vicinity of the left end of the work area 110 after the enlargement. In the example illustrated in FIG. 5B, the distance between the left end of the work area 110 and the component information menu 111 arranged in the vicinity of the left end is maintained to be the same before and after the enlargement.

The rendering option menu 112, the operation option menu 113, and the XYZ marker 114, which were arranged in the vicinity of the right end of the work area 110 before the enlargement, are also still arranged in the vicinity of the right end of the work area 110 after the enlargement. In the example illustrated in FIG. 5B, the rendering option menu 112, the operation option menu 113, and the XYZ marker 114 arranged in the vicinity of the right end of the work area 110 remain at the same positions before and after the enlargement.

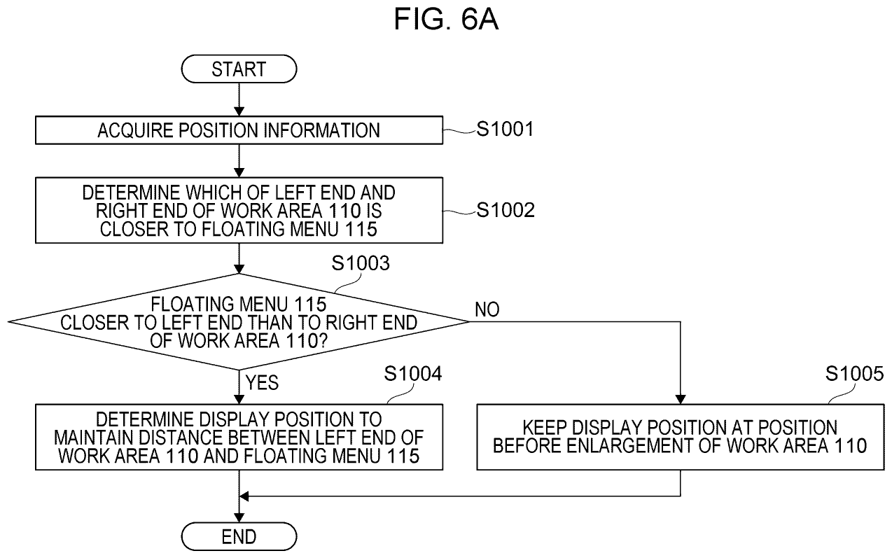

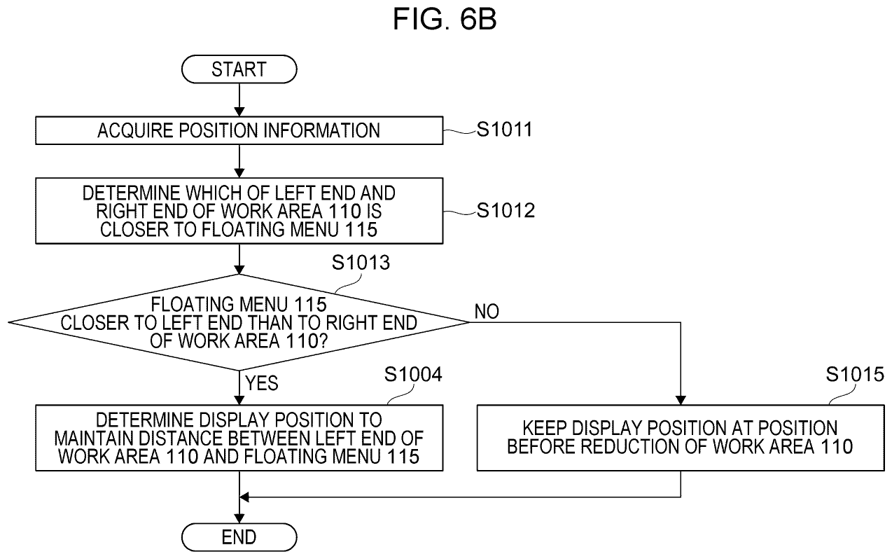

FIGS. 6A and 6B are diagrams illustrating examples of a flow of processes for determining the display position of the floating menu 115 after the enlargement or the reduction of the work area 110. FIG. 6A illustrates an example of a case where the work area 110 is enlarged, and FIG. 6B illustrates an example of a case where the work area 110 is reduced.

A flow of processes in response to enlargement of the work area 110 will be described. Assume that the enlargement is implemented with the left end of the work area 110 illustrated in FIG. 4 moved in a direction away from the right end. First, the processor 31 of the user terminal 30 acquires the position information of the floating menu 115 with respect to the work area 110 before the enlargement (step 1001).

Next, the processor 31 determines which of the left end and the right end of the work area 110 is closer to the floating menu 115 (step 1002). When the floating menu 115 is closer to the left end than to the right end of the work area 110 (YES in step 1003), the processor 31 determines the display position to maintain the distance between the left end of the work area 110 and the floating menu 115 (step 1004). On the other hand, when the floating menu 115 is closer to the right end than to the left end of the work area 110 (NO in step 1003), the processor 31 keeps the display position of the floating menu 115 at the position before the enlargement of the work area 110 (step 1005).

A flow of processes in response to reduction of the work area 110 will be described. Assume that the reduction is implemented with the left end of the work area 110 illustrated in FIG. 4 moving in a direction toward the right end. The processor 31 of the user terminal 30 acquires the position information of the floating menu 115 with respect to the work area 110 before the reduction (step 1011).

The processor 31 determines which of the left end and the right end of the work area 110 is closer to the floating menu 115 (step 1012). When the floating menu 115 is closer to the left end than to the right end of the work area 110 (YES in step 1013), the processor 31 determines the display position to maintain the distance between the left end of the work area 110 and the floating menu 115 (step 1014). On the other hand, when the floating menu 115 is closer to the right end than to the left end of the work area 110 (NO in step 1013), the processor 31 keeps the display position of the floating menu 115 at the position before the reduction of the work area 110 (step 1005).

While all the floating menus 115 illustrated in FIG. 4 are arranged inside the work area 110, this should not be construed in a limiting sense. The present exemplary embodiment is also applicable to a configuration in which the floating menus 115 are arranged outside the work area 110.

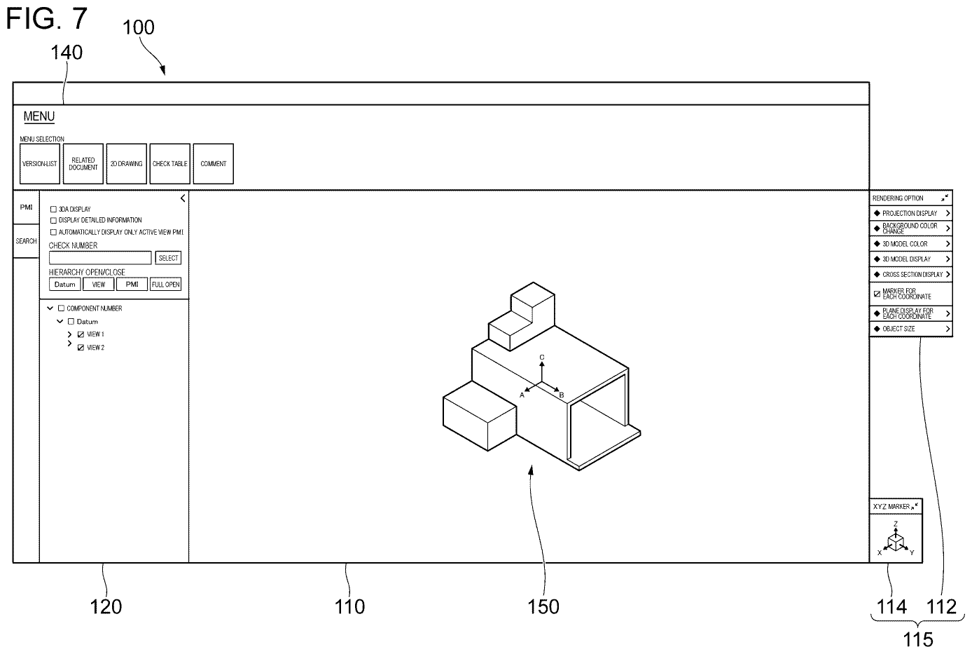

FIG. 7 is a diagram illustrating an example of the browser window 100 when the floating menus 115 are arranged outside the work area 110. An example is described with reference to FIG. 7 where, as in FIG. 4, the user uses a web application for editing a 3D model. The browser window 100 includes the work area 110, the tree 120, and the tab 140.

Referring to FIG. 7, the rendering option menu 112 and the XYZ marker 114, each serving as the floating menu 115, are arranged outside the work area 110. Also with this configuration, when the work area 110 is enlarged or reduced, the display position of the floating menu 115 after the enlargement or the reduction is determined based on the position of the floating menu 115 with respect to the work area 110 before the enlargement or the reduction.

A case where the work area 110 is enlarged toward the upper side on the screen illustrated in FIG. 7 will be described. In this case, the work area 110 is enlarged with the upper end of the work area 110 moving in a direction away from the lower end on the opposite side. Based on the distances from the floating menu 115 to the upper end and to the lower end of the work area 110 before the enlargement, the processor 31 determines the display position of the floating menu 115 after the enlargement.

The rendering option menu 112 is closer to the upper end than to the lower end of the work area 110. In this case, the processor 31 moves the display position of the rendering option menu 112 toward the upper side, which is the downstream side in the enlargement direction. Here, for example, the processor 31 determines the display position of the rendering option menu 112 after the enlargement to maintain the distance between the upper end of the work area 110 and the rendering option menu 112.

The XYZ marker 114 is closer to the lower end than to the upper end of the work area 110. In this case, the processor 31 moves the display position in a manner different from that in a case where the display position is closer to the upper end than to the lower end of the work area 110. For example, the processor 31 keeps the XYZ marker 114 at the position before the enlargement.

The method of determining the display position of the floating menu 115 may be different between cases where the floating menu 115 is located inside and outside the work area 110. For example, when the position is located inside the work area 110, the display position of the floating menu 115 may be determined as described with reference to FIG. 4, and when the position is located outside the work area 110, the floating menu 115 may be kept at the position before the enlargement.

With this configuration, when the floating menu 115 is located in a specific area, the processor 31 moves the floating menu 115 toward the downstream side in the enlargement direction or the reduction direction.

The search menu 130 illustrated in FIG. 4 may be configured to be switchable between a state where the display position is fixed with respect to the work area 110 and a state where the display position is movable with respect to the work area 110.

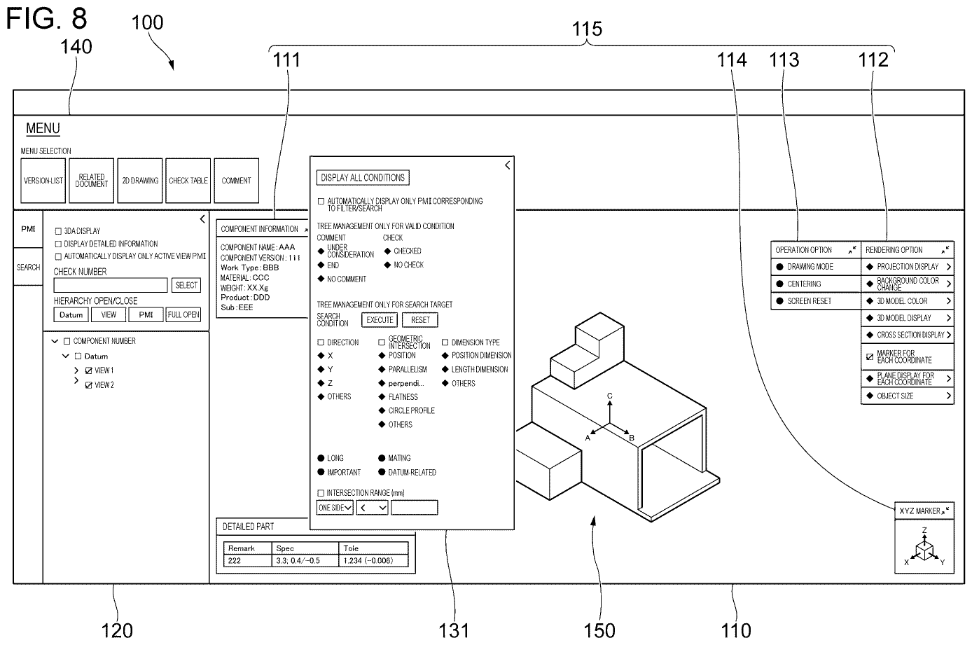

FIG. 8 is a diagram illustrating an example in which a search menu 131 for performing a search on the tree 120 is displayed to be movable with respect to the work area 110.

The search menu 131 is in a display format corresponding to a case where the search menu 130 illustrated in FIG. 4 is switched to a state of being movable with respect to the work area 110. For example, when the search menu 130 is clicked and dragged, the display format is switched. The display position of the search menu 131, for example, can be freely moved in the browser window 100. For example, as illustrated in FIG. 8, the search menu 131 is displayed inside and outside of the work area 110 at the same time.

Search conditions displayed in the search menu 131 are more detailed than those in the search menu 130. The user hoping to perform a more detailed search switches the display format of the search menu 130 to the search menu 131.

The display position of the search menu 131 after the enlargement or the reduction of the work area 110 is determined in the same manner as the floating menu 115. The display position of the search menu 131 may remain at the same position regardless of whether the work area 110 is enlarged or reduced. The display position of the search menu 131, which can move to be inside and outside of the work area 110, remains at the original position regardless of whether the work area 110 is enlarged or reduced.

As described above, the processor 31 determines the display position of the floating menu 115 after the enlargement or reduction based on the positional relationship between the floating menu 115 and both ends of the work area 110 in the enlargement or reduction direction of the work area 110. The processor 31 provides a plurality of references in the work area 110 and determines the display position of the floating menu 115 based on the positional relationship between the plurality of references and the floating menu 115. The plurality of references are not limited to both ends of the work area 110.

For example, the processor 31 may use, as a reference for determining the display position of the floating menu 115, a center line that divides the work area 110 into two equal areas in the enlargement or reduction direction of the work area 110. The processor 31 determines which of both ends and the center line of the work area 110 in the enlargement or reduction direction is closest to the floating menu 115 before the enlargement or the reduction of the work area 110. The processor 31 determines the display position of the floating menu 115 after the enlargement or reduction to maintain the distance from the closest reference.

### Second Exemplary Embodiment

The first exemplary embodiment relates to a configuration in which when the work area 110 is enlarged or reduced, the display position of the floating menu 115 is determined based on the distances between the floating menu 115 and both ends of the work area 110 in the enlargement or reduction direction. In a second exemplary embodiment, when the work area 110 is enlarged or reduced, the display position is determined based on the positional relationship between the floating menu 115 and the corner, of the four corners of the work area 110, that is closest to the floating menu 115. In the following description, the same components as those in the first exemplary embodiment are denoted by the same reference numerals, and a detailed description thereof will be omitted.

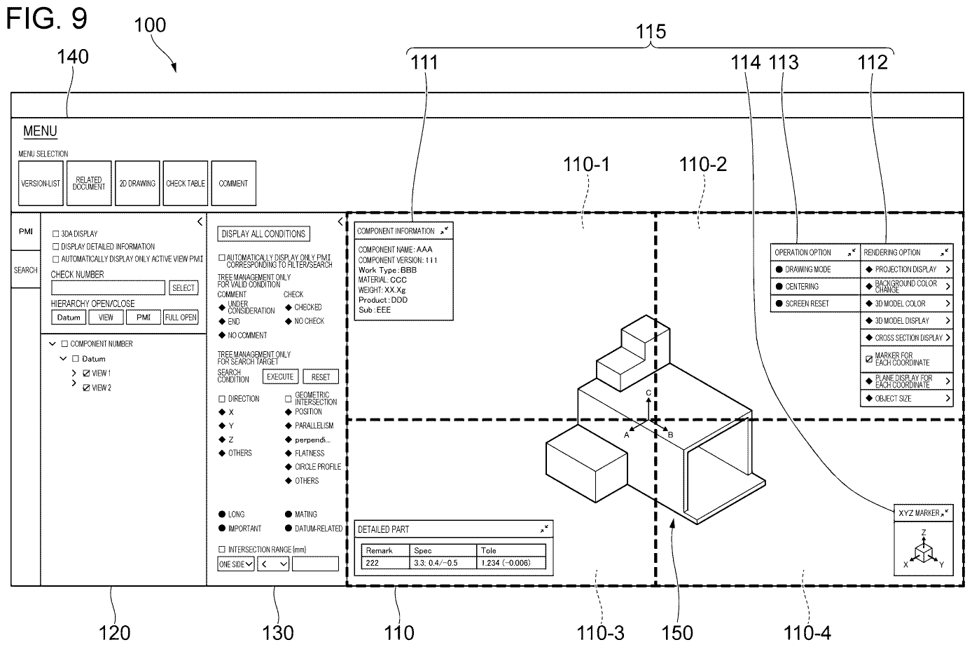

FIG. 9 is a diagram for explaining how the display position of the floating menu 115 is determined according to the second exemplary embodiment.

As illustrated in the figure, the work area 110 is divided into four areas 110-1, 110-2, 110-3, and 110-4. Depending on which area the floating menu 115 belongs to, the display position of the work area 110 after the enlargement or reduction is determined. The floating menu 115 belonging to an area means that, for example, the center of the floating menu 115 belongs to the area. Alternatively, the areas of portions of the floating menu 115 that overlap with the respective areas may be calculated, and the floating menu 115 may be determined to belong to the area with the largest area.

The display position of the floating menu 115 after the enlargement or reduction of the work area 110 is determined based on the positional relationship between the floating menu 115 and a corner of the work area 110 included in the area to which the floating menu 115 belongs. For example, the display position of the floating menu 115 after the enlargement or reduction of the work area 110 is determined to maintain the positional relationship with the corner of the work area 110 before the enlargement or reduction of the work area 110.

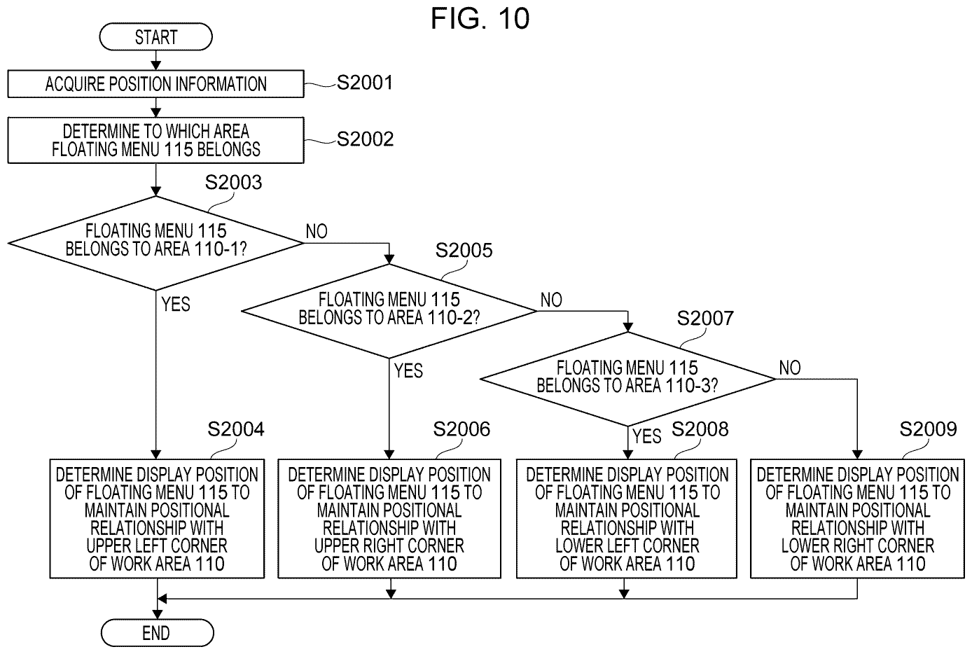

FIG. 10 is a diagram illustrating an example of a flow of processes for determining the display position of the floating menu 115 after the enlargement or reduction of the work area 110.

First, the processor 31 of the user terminal 30 acquires the position information of the floating menu 115 with respect to the work area 110 before the enlargement or reduction (step 2001).

Then, the processor 31 determines to which area the floating menu 115 belongs (step 2002). For example, the processor 31 determines that an area to which the center of the floating menu 115 belongs as the area to which the floating menu 115 belongs. When the floating menu 115 belongs to the area 110-1 (YES in step 2003), the processor 31 determines the display position of the floating menu 115 to maintain the positional relationship with the upper left corner of the work area 110 (step 2004). For example, the processor 31 maintains the positions of the floating menu 115 to be the same before and after the enlargement or reduction of the work area 110 on coordinates with the upper left corner of the work area 110 serving as the origin. When the upper left corner of the work area 110 serving as the origin moves due to enlargement or reduction, the floating menu 115 moves to follow the movement.

When the floating menu 115 belongs to the area 110-2 (YES in step 2005), the processor 31 determines the display position of the floating menu 115 to maintain the positional relationship with the upper right corner of the work area 110 (step 2006). When the floating menu 115 belongs to the area 110-3 (YES in step 2007), the processor 31 determines the display position of the floating menu 115 to maintain the positional relationship with the lower left corner of the work area 110 (step 2008).

When it is determined NO in steps 2003, 2005, and 2007, the floating menu 115 belongs to the area 110-4. In this case, the processor 31 determines the display position of the floating menu 115 to maintain the positional relationship with the lower right corner of the work area 110 (step 2009).

As described above, in the second exemplary embodiment, the display position is determined based on the positional relationship between the floating menu 115 and the corner, of the four corners of the work area 110, that is closest to the floating menu 115.

The present exemplary embodiment is also applicable to a configuration in which the floating menu 115 is arranged outside the work area 110. For example, the display position of the floating menu 115 is determined to maintain a position on coordinates with the closest corner of the work area 110 serving as the origin.

Although the exemplary embodiments have been described above, the technical scope of the present disclosure is not limited to the scope of the above-described exemplary embodiments. For example, while the position information acquired by the processor 31 is described as information on a position with respect to the work area 110, a configuration may be employed in which the processor 31 acquires coordinates in the entire screen of the display device 34 and determines a display position in the entire screen.

While the work area 110 and the floating menu 115 are respectively described as the first image and the second image for example in the above-described exemplary embodiments, this should not be construed in a limiting sense. The first image may be any image that is displayed on the user terminal 30. For example, the image may be an area for displaying a user operation target, such as a web application display area or a document display area of document management software. The second image may be any image that is movable with respect to the first image. The second image is an image indicating information related to a function of the first image or an operation on the first image. The second image may be, for example, a popup menu displayed in response to a user operation such as a right-click on a mouse. In this case, when the first image is enlarged or reduced, the display position of the popup menu changes.

The technical scope of the present disclosure also covers combinations of two or more of the above-described exemplary embodiments and various modifications or improvements made to the above-described exemplary embodiments.

In the exemplary embodiments, the processes are performed by any computer. Any computer may perform the processes by using a processor serving as hardware, a program serving as software, or combination of these. In this case, the processor is configured to perform various processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (such as, for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

### Appendix

1

According to an aspect of the present disclosure, there is provided an information processing system including a processor configured to: acquire position information that is information on a position of a second image with respect to a first image, the second image being movable with respect to the first image; and determine, based on the acquired position information, a display position of the second image after enlargement or reduction of the first image in a direction of the enlargement or reduction.

2

The information processing system according to (((1))), wherein the processor is configured to determine, when the first image is enlarged with one end of the first image moved in a direction away from an other end of the first image, the display position of the second image based on a distance between the second image and the one end and a distance between the second image and the other end.

3

The information processing system according to (((2))), wherein the processor is configured to move, when the distance between the second image and the one end is shorter than the distance between the second image and the other end, the second image toward a downstream side in a moving direction of the one end from a position before the enlargement of the first image.

4

The information processing system according to (((3))), wherein the processor is configured to determine the display position of the second image to maintain the distance between the one end of the first image and the second image.

5

The information processing system according to (((2))), wherein the processor is configured to keep, when the distance between the second image and the one end is longer than the distance between the second image and the other end, the second image at a position before the enlargement of the first image.

6

The information processing system according to (((1))), wherein the processor is configured to determine, when the first image is reduced with one end of the first image moved in a direction toward an other end, the display position of the second image based on a distance between the second image and the one end and a distance between the second image and the other end.

7

The information processing system according to (((6))), wherein the processor is configured to move, when the distance between the second image and the one end is shorter than the distance between the second image and the other end, the second image toward a downstream side in a moving direction of the one end from a position before the reduction of the first image.

8

The information processing system according to (((7))), wherein the processor is configured to determine the display position of the second image to maintain the distance between the one end of the first image and the second image.

9

The information processing system according to (((6))), wherein the processor is configured to keep, when the distance between the second image and the one end is longer than the distance between the second image and the other end, the second image at a position before the reduction of the first image.

10

The information processing system according to (((1))), wherein the processor is configured to determine the display position of the second image based on a positional relationship between the second image and a corner, of four corners of the first image, closest to the second image.

11

The information processing system according to (((10))), wherein the processor is configured to determine the display position of the second image to maintain the positional relationship between the corner and the second image to be same before and after the enlargement or reduction.

12

The information processing system according (((1))), wherein the processor is configured to move, when the second image is located in a specific area of the first image, the display position of the second image toward a downstream side in a direction of the enlargement or reduction of the first image.

13

The information processing system according to any one of (((1))) to (((12))), wherein the first image is a work area configured to display a target of work by a user.

14

The information processing system according to (((13))), wherein the second image is an image indicating information on an operation on the work area.

15

The information processing system according to (((13))) or (((14))), wherein the work area is enlarged or reduced depending on whether a function related to displaying of the work area is displayed.

What is claimed is:

1. An information processing system comprising:
a processor configured to:
acquire position information that is information on a position of a second image with respect to a first image, the second image being movable with respect to the first image; and
determine, based on the acquired position information, a display position of the second image after enlargement or reduction of the first image in a direction of the enlargement or reduction.

2. The information processing system according to claim 1, wherein the processor is configured to determine, when the first image is enlarged with one end of the first image moved in a direction away from an other end of the first image, the display position of the second image based on a distance between the second image and the one end and a distance between the second image and the other end.

3. The information processing system according to claim 2, wherein the processor is configured to move, when the distance between the second image and the one end is shorter than the distance between the second image and the other end, the second image toward a downstream side in a moving direction of the one end from a position before the enlargement of the first image.

4. The information processing system according to claim 3, wherein the processor is configured to determine the display position of the second image to maintain the distance between the one end of the first image and the second image.

5. The information processing system according to claim 2, wherein the processor is configured to keep, when the distance between the second image and the one end is longer than the distance between the second image and the other end, the second image at a position before the enlargement of the first image.

6. The information processing system according to claim 1, wherein the processor is configured to determine, when the first image is reduced with one end of the first image moved in a direction toward an other end, the display position of the second image based on a distance between the second image and the one end and a distance between the second image and the other end.

7. The information processing system according to claim 6, wherein the processor is configured to move, when the distance between the second image and the one end is shorter than the distance between the second image and the other end, the second image toward a downstream side in a moving direction of the one end from a position before the reduction of the first image.

8. The information processing system according to claim 7, wherein the processor is configured to determine the display position of the second image to maintain the distance between the one end of the first image and the second image.

9. The information processing system according to claim 6, wherein the processor is configured to keep, when the distance between the second image and the one end is longer than the distance between the second image and the other end, the second image at a position before the reduction of the first image.

10. The information processing system according to claim 1, wherein the processor is configured to determine the display position of the second image based on a positional relationship between the second image and a corner, of four corners of the first image, closest to the second image.

11. The information processing system according to claim 10, wherein the processor is configured to determine the display position of the second image to maintain the positional relationship between the corner and the second image to be same before and after the enlargement or reduction.

12. The information processing system according to claim 1, wherein the processor is configured to move, when the second image is located in a specific area of the first image, the display position of the second image toward a downstream side in a direction of the enlargement or reduction of the first image.

13. The information processing system according to claim 1, wherein the first image is a work area configured to display a target of work by a user.

14. The information processing system according to claim 13, wherein the second image is an image indicating information on an operation on the work area.

15. The information processing system according to claim 13, wherein the work area is enlarged or reduced depending on whether a function related to displaying of the work area is displayed.
